(19) United States
(12) Patent Application Publication
(10) Pub. No.: US 2023/0035629 A1
(43) Pub. Date: Feb. 2, 2023

(54) READING DEVICE AND METHOD

(71) Applicant: TOSHIBA TEC KABUSHIKI KAISHA, Tokyo (JP)

(72) Inventors: Hidehiro NAITO, Mishima Shizuoka (JP); Takuya TAKASU, Shizuoka Shizuoka (JP); Tomonori SUGIYAMA, Yokohama Kanagawa (JP); Ichiro FUKUZAWA, Ota Tokyo (JP); Hiroki TAKEDA, Mishima Shizuoka (JP)

(73) Assignee: TOSHIBA TEC KABUSHIKI KAISHA, Tokyo (JP)

(21) Appl. No.: 17/742,895

(22) Filed: May 12, 2022

(30) Foreign Application Priority Data
Jul. 27, 2021 (JP) 2021-122360

(51) Int. Cl. G06Q 20/20; G06K 7/12

(52) U.S. Cl. CPC G06Q 20/208; G06K 7/12

(57) ABSTRACT

A first reader is configured to read an invisible code symbol attached to each package surface of a commodity from an image of the commodity acquired by an imaging device. A second reader is configured to read a predetermined flag figure attached to a commodity as a service target. A third reader is configured to read a service label representing a content of a service that is provided during purchase of the commodity on condition that the second reader succeeds to read the flag figure. An output is configured to output a reading result of the first reader. If the third reader reads the service label, outputting a reading result of the third reader. The flag figure is attached to each of the package surfaces to which the code symbol is attached. The second reader starts reading the flag figure after the first reading unit reads the code symbol.

### CROSS-REFERENCE TO RELATED APPLICATION

This application is based upon and claims the benefit of priority from Japanese Patent Application No. 2021-122360, filed on Jul. 27, 2021, the entire contents of which are incorporated herein by reference.

### FIELD

Embodiments described herein relate generally to a reading device and a method.

### BACKGROUND

In the related art, in a retail store where commodities are sold, a reading device that reads a code symbol such as a barcode or a two-dimensional code attached to a commodity is used. For example, in the retail store, a registration process and the like of a commodity that is purchased by a customer are executed based on information, such as an identifier capable of identifying a commodity, which is read by the reading device from the code symbol.

In addition, in the retail store, a label (hereinafter, referred to as “service label”) displaying the content of a service such as price reduction or discount is attached to a commodity as a target of the service. In this case, in order to prevent an operator from overlooking or forgetting to read the service label, a flag seal representing a predetermined figure (hereinafter, also referred to as “flag figure”) that can be read by the reading device is attached to the commodity as the service target. If the flag figure (flag seal) is read during the reading of the code symbol, the reading device executes a process such as notification to urge the operator to read the service label.

In addition, recently, in a package of a commodity, a plurality of code symbols are embedded in the form of a digital watermark. This code symbol is invisible to persons but can be read by the reading device. Therefore, for example, by embedding the code symbol in each of the package surfaces of the commodity, the code symbol can be read in any region of the commodity, and time and effort for searching for the code symbol can be saved.

In a configuration in which one visible code symbol is attached to a package of a commodity, a flag figure is attached to the vicinity of the code symbol to prevent an operator from forgetting to read the flag figure. However, in the configuration in which the invisible code symbols are attached to the package surfaces, a code symbol to be read cannot be specified. Therefore, it is difficult to attach the flag figure to the vicinity of the code symbol. In addition, if the flag seal (flag figure) is carelessly attached, the flag figure cannot be read during the reading of the code symbol, and an operator may forget to read the flag figure. In this case, an operator may proceed transaction without realizing the presence of the service label and providing the service such as price reduction. Therefore, there is a room for further improvement.

### DESCRIPTION OF THE DRAWINGS

FIG. 1 is a perspective view illustrating an overall configuration of a POS system according to at least one embodiment;

FIG. 2 is a diagram illustrating an example of a configuration of a reading device according to at least one embodiment;

FIG. 3 is a diagram illustrating an example of an external appearance of a commodity according to at least one embodiment;

FIG. 4 is a diagram illustrating an example of hardware configurations of the reading device and the POS terminal according to at least one embodiment;

FIG. 5 is a diagram illustrating an example of functional configurations of the reading device and the POS terminal according to at least one embodiment; and

FIG. 6 is a flowchart illustrating an example of a process that is executed by the reading device according to the embodiment.

### DETAILED DESCRIPTION

Embodiments provide a reading device that can efficiently read a flag figure from a commodity to which an invisible code symbol is attached, and a method.

In general, according to at least one embodiment, a reading device includes first reading means (first reader), second reading means (second reader), third reading means (third reader), and output means (output). The first reading means reads an invisible code symbol attached to each of package surfaces of a commodity from an image of the commodity acquired by an imaging device. The second reading means reads a predetermined flag figure attached to a commodity as a service target from the image. The third reading means reads a service label representing a content of a service that is provided during purchase of the commodity from the image on a condition that the second reading means succeeds to read the flag figure. The output means outputs a reading result of the first reading means and, if the third reading means reads the service label, outputs a reading result of the third reading means. In addition, the flag figure is attached to each of the package surfaces to which the code symbol is attached, and the second reading means starts reading the flag figure after the first reading means reads the code symbol.

Hereinafter, a symbol reading device and a method according to an embodiment will be described. In the following embodiment, an application example to a point of sales (POS) system provided in a store of a retail store will be described, but the present disclosure is not limited to this embodiment.

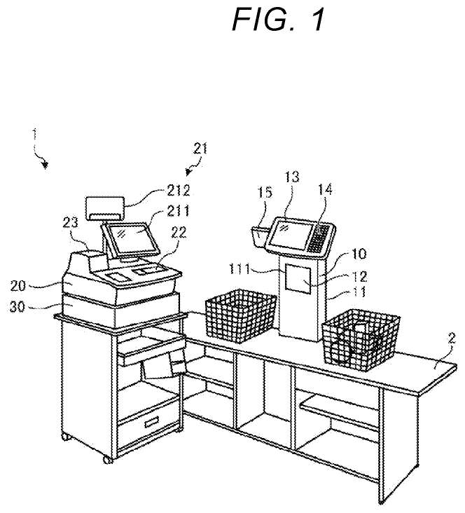

FIG. 1 is a perspective view illustrating an overall configuration of a POS system 1. As illustrated in FIG. 1, the point of sales (POS) system 1 includes: a reading device 10; and a POS terminal 20 that executes data processing based on data read by the reading device 10.

The reading device 10 stands in a place (substantially center portion) where an operator and a customer substantially confront to each other in a checkout counter 2 for placing a shopping basket containing commodities. The POS terminal 20 is provided in the vicinity of one end portion of the checkout counter 2. The reading device 10 and the POS terminal 20 are communicatively connected to each other via a transmission line (not illustrated). The reading device 10 and the POS terminal 20 configure the POS system 1.

The POS terminal 20 executes sales data processing including a registration process and a settlement process of a commodity to be purchased by a customer based on information of the commodities read by the reading device 10. The POS terminal 20 includes two display units 21 (a first display unit 211 and a second display unit 212) for the operator and the customer, a keyboard 22, and a receipt printer 23. In addition, the POS terminal 20 is provided on a drawer 30 that stores coins and bills to freely put them into or out from the drawer.

The display units 21 are display devices with a touch panel that are configured with display devices such as liquid crystal displays (LCD). The keyboard 22 is an input device including various keyboards such as numeric keys or a subtotal key and a locking key. The receipt printer 23 is, for example, a thermal printer and prints a receipt according to the sales data processing that is executed by the POS terminal 20.

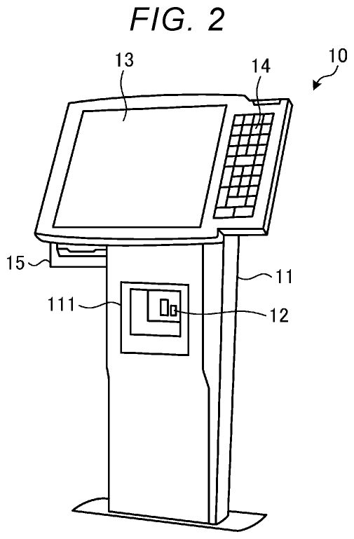

Next, a configuration of the reading device 10 will be described. FIG. 2 is a diagram illustrating one example of the configuration of the reading device 10. Here, FIG. 2 illustrates a state where the reading device 10 is seen from a side where an imaging window 111 is provided (stand position side of the operator).

The reading device 10 includes a main body unit 11, an imaging unit 12 (imager), a first display unit 13, a keyboard 14, and a second display unit 15.

The main body unit 11 is formed in a substantially cuboid shape and stands on the checkout counter 2. Here, the height of the main body unit 11 standing on the checkout counter 2 is preferably equal to or less than the height of eyes of the operator.

The imaging window 111 as an opening portion is provided on the main body unit 11 on the stand position side of the operator. The imaging unit 12 is provided in the imaging window 111. The operator operates the imaging unit 12 to image (read) a commodity brought by the customer, that is a commodity to be purchased by holding the commodity up to the imaging window 111.

The imaging unit 12 is an example of the imaging device. The imaging unit 12 includes an imaging element such as a charge coupled device (CCD) or a complementary MOS (CMOS) and an optical system such as an imaging lens. The imaging lens forms an image of an imaging area on the imaging element, the imaging area being imaged by the imaging element. The imaging area refers to an area of the imaging element on which the imaging lens forms an image through the imaging window 111. The imaging unit 12 images the outside of the main body unit 11 through the imaging window 111. Specifically, the imaging unit 12 images the commodity held up to the imaging window 111.

Here, the commodity is an article such as food or cloth that is sold in the store, and is packaged by a package having a box or bag shape. A code symbol such as a barcode or a two-dimensional code is attached to the package of the commodity by printing or the like. The code symbol contains information such as a commodity code based on which the type of the commodity is identifiable in a state where the information is encoded in a form defined by a predetermined standard such as Code 128.

In addition, in the embodiment, a plurality of code symbols are attached to the package of the commodity as invisible information by a digital watermarking technique such as Digimarc Barcode (registered trademark). This code symbol is embedded, for example, in the entire package of the commodity as a pattern, and can be read by the reading device 10. As a result, the reading device 10 can read the code symbol even if any region of the commodity is imaged. A method of implementing the invisible code symbol is not limited to the digital watermarking technique, and the invisible code symbol may be implemented using another technique.

If the code symbol is read from the commodity, the reading device 10 outputs information regarding the commodity code contained in the code symbol as the reading result. If the code symbol is read by the reading device 10, the POS terminal 20 executes sales data processing including a registration process and a settlement process of the commodity based on the commodity code contained in the code symbol.

In at least one embodiment, the code symbol is attached to the entire package of the commodity but is not limited thereto. The code symbol may be attached to one surface of a plurality of package surfaces or to some of the package surfaces.

In addition, a label (hereinafter, referred to as “service label”) representing the content of a service to be provided such as price reduction, discount, or point addition in a visible state is added to a package of a commodity as a target to which the service is to be provided. The service label is represented by a predetermined figure or pattern and is attached to each of commodities as targets to which the service is to be provided. For example, the service label is attached to a commodity or the like where a freshness date or an expiration date is expired.

If the service label is read from the commodity, the reading device 10 outputs the service content represented by the service label as the reading result. If the service label is read by the reading device 10, the POS terminal 20 executes sales data processing to provide the service content (for example, price reduction or discount) corresponding to the service label.

The attachment positions or number of the service labels is not particularly limited. In addition, in the embodiment, the reading device 10 is configured to read the service label. However, the reading device 10 may be configured to receive an input of the service content of the service label through the keyboard 14 and the like by visual recognition and operation of the operator.

In addition, a flag seal representing that the service label is attached to the package of the commodity to which the service label is attached. On the flag seal, a flag figure such as a predetermined figure or pattern including a circle or a double circle is shown.

If the flag seal (flag figure) is read from the commodity, the reading device 10 executes, for example, a process of notifying that the service label is attached to urge the operator to read the service label. As a result, the reading device 10 can prevent the operator from forgetting to read the service label.

Incidentally, in a configuration in which one visible code symbol is attached to a package of a commodity, a flag seal is attached to the vicinity of the code symbol to prevent an operator from forgetting to read the flag seal. However, in a configuration in which a plurality of invisible code symbols are attached to each of package surfaces as in at least one embodiment, an operator cannot specify a code symbol to be read. Therefore, it is difficult to attach the flag seal to the vicinity of the code symbol. In addition, if the flag seal is carelessly attached, the flag seal cannot be read during the reading of the code symbol, and the operator may forget to read the flag seal.

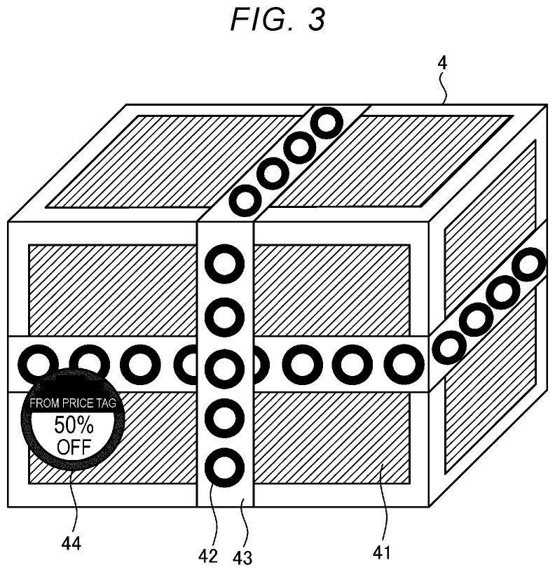

Accordingly, in the embodiment, the flag seal is attached to at least each of package surfaces to which the code symbol is attached to prevent the operator from forgetting to read the flag seal. Here, FIG. 3 is a diagram illustrating an example of an external appearance of the commodity according to the embodiment.

As illustrated in FIG. 3, code symbols 41 are embedded in each of package surfaces of a commodity 4 in the form of a digital watermark. More specifically, a plurality of digital watermark code symbols 41 are embedded in each of six package surfaces of the commodity 4 having a box shape. In FIG. 3, a region in which a plurality of the code symbols 41 which are the same are embedded is hatched.

In addition, if the commodity 4 is a commodity as the service target, a service label 44 is attached to the package surface. FIG. 3 illustrates an example where the service label 44 representing price reduction (discount) of half of a price of the commodity is attached.

In addition, a flag seal 43 containing a flag figure 42 is attached to each of package surfaces of the commodity 4 to which the service label 44 is attached. Here, FIG. 3 illustrates an example where the flag seal 43 as a seal member having a tape shape is transversely attached to each of the surfaces of the package. A plurality of flag figures 42 are continuously printed on the flag seal 43. By using the flag seal 43 having this configuration, the flag figures can be efficiently attached to the package surface.

This way, in the commodity 4, the flag seal 43 (flag figure) is attached to each of the surfaces of the package to which the code symbol 41 is attached. As a result, in at least one embodiment, if the code symbol 41 is read from any one of the package surfaces of the commodity 4, the flag figure attached to the package surface can be efficiently read. Therefore, the operator can be prevented from forgetting to read the flag seal.

FIG. 3 illustrates the example where the service label 44 is attached to overlap with the flag seal 43. However, the attachment positions or number of the service labels 44 is not particularly limited to the example of FIG. 3.

Referring back to FIG. 2, the description of the reading device 10 is continued. The first display unit 13 is a display device for the operator. The first display unit 13 is provided above the imaging window 111. The first display unit 13 is a display device with a touch panel that is configured with a display device such as a liquid crystal display (LCD). The first display unit 13 displays article names, prices, and the like of commodities that are registered in the registration process by the POS terminal 20 to the operator.

The keyboard 14 is provided in the vicinity (side portion) of the first display unit 13. The keyboard 14 includes various keys. FIG. 2 illustrate the example where the first display unit 13 and the keyboard 14 are integrally provided. However, the first display unit 13 and the keyboard 14 may be provided separately from each other.

The second display unit 15 is a display device with a touch panel that is configured with a display device such as a liquid crystal display (LCD). The second display unit displays article names, prices, and the like of commodities that are registered in the sales registration process by the POS terminal 20 to the customer.

The configuration of the reading device 10 is not limited to the example of FIG. 1. For example, the reading device 10 may include an illuminating device that illuminates the imaging area of the imaging unit 12 in the imaging window 111.

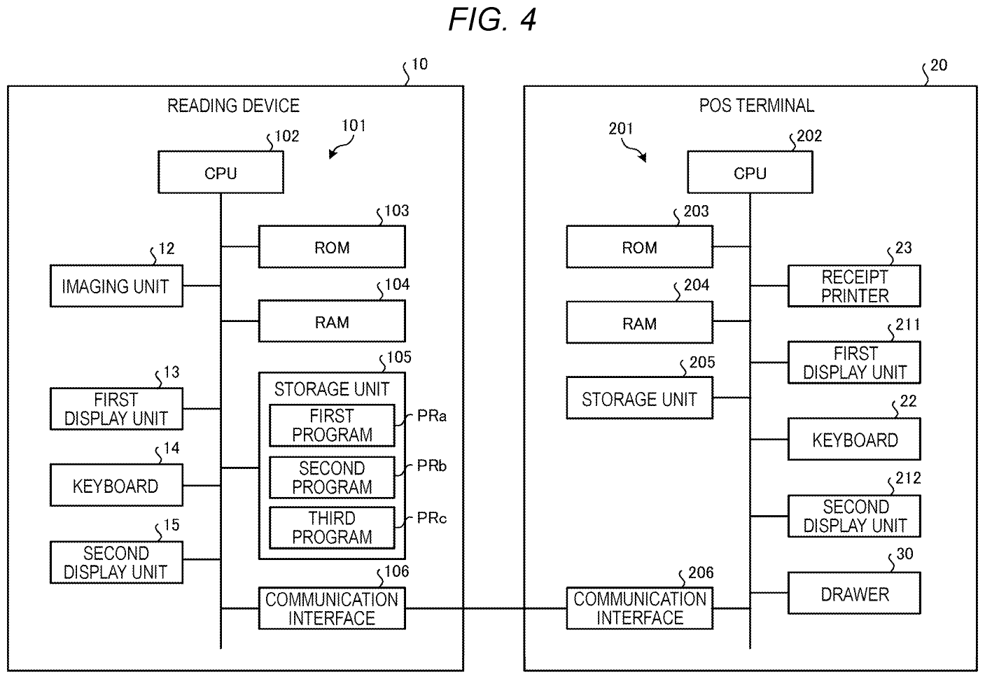

FIG. 4 is a block diagram illustrating an example of hardware configurations of the reading device 10 and the POS terminal 20.

As illustrated in FIG. 4, the reading device 10 includes a microcomputer 101 in addition to the imaging unit 12, the first display unit 13, the keyboard 14, and the second display unit 15 described above.

The microcomputer 101 includes a central processing unit (CPU) 102, a read only memory (ROM) 103, and a random access memory (RAM) 104. The CPU 102 is an example of a processor. The CPU 102 integrally controls each of the units of the reading device 10. The ROM 103 stores fixed information such as a control program in advance. The RAM 104 stores various data in a rewritable manner and functions as a work area or the like. Accordingly, the microcomputer 101 configures an information processing unit that executes information processing. The entirety or a part of the RAM 104 may be configured with a non-volatile storage medium. In addition, the microcomputer 101 has a time tracking function such as a real time clock (RTC).

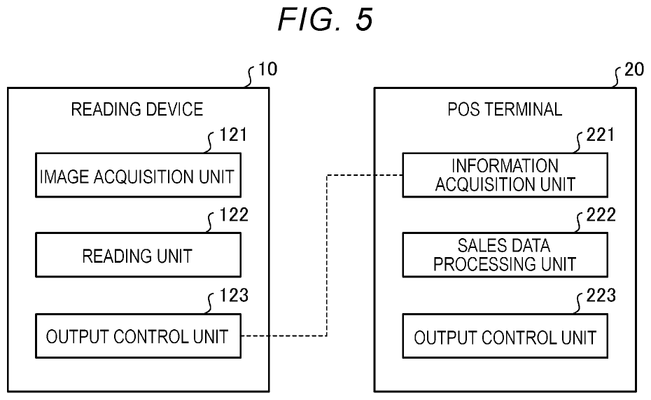

In addition, the reading device 10 includes a storage unit 105. The storage unit 105 is a storage device such as a hard disk drive (HDD) or a solid state drive (SSD). The storage unit 105 stores various programs or various data relating to the operation of the reading device 10. For example, the reading device 10 stores a control program for implementing each of functional configurations (refer to FIG. 5) described below.

In addition, the storage unit 105 stores a program for reading various information from the image of the commodity acquired by the imaging unit 12. Specifically, the storage unit 105 stores a first program PRa for reading the code symbol attached to the package of the commodity. In addition, the storage unit 105 stores a second program PRb for reading the flag figure attached to the package of the commodity. In addition, the storage unit 105 stores a third program PRc for reading the service label attached to the package of the commodity.

Each of the first program PRa, the second program PRb, and the third program PRc includes the content of a process (a function or an algorithm) corresponding to information as a target to be read. For example, the first program PRa includes a process for implementing the code symbol embedded as digital watermark information, a process relating to the detection of the code symbol, and a process for decoding the code symbol. In addition, the second program PRb includes a process relating to the recognition of the flag figure. In addition, the third program PRc includes a process relating to the recognition of the service label. Here, a reading method relating to the reading of the code symbol or the reading of various figures (the flag figure and the service label) is not particularly limited, and various techniques can be used.

The information stored in the storage unit 105 is not limited to the example. For example, the storage unit 105 may store information representing characteristics of the shape or pattern of the flag figure. In addition, the storage unit 105 may store information where characteristics of the shape or pattern of the service label are correlated with the service content corresponding to the service label. In addition, the storage unit 105 may store a PLU file described below.

In addition, the reading device 10 includes a communication interface 106. The communication interface 106 executes data communication with another device (POS terminal 20) via a connection line such as a LAN cable.

On the other hand, as illustrated in FIG. 4, the POS terminal 20 includes a microcomputer 201 in addition to the first display unit 211, the second display unit 212, the keyboard 22, the receipt printer 23, and the drawer 30 described above.

The microcomputer 201 includes, for example, a CPU 202, a ROM 203, and a RAM 204. The CPU 202 is an example of a processor. The CPU 202 integrally controls each of the units of the POS terminal 20. The ROM 203 stores fixed information such as a control program in advance. The RAM 204 stores various data in a rewritable manner and functions as a work area or the like. Accordingly, the microcomputer 201 configures an information processing unit that executes information processing. The entirety or a part of the RAM 204 may be configured with a non-volatile storage medium. In addition, the microcomputer 201 has a time tracking function such as a RTC.

In addition, the POS terminal 20 includes a storage unit 205. The storage unit 205 is a storage device such as a HDD or a SSD. A storage unit 205 stores various programs or various data relating to the operation of the POS terminal 20. For example, the storage unit 205 stores a program for the sales data processing. In addition, the storage unit 205 store the PLU file.

The PLU file is a data file where a commodity code of each of commodities that are sold in a store is correlated with information (hereinafter, also referred to as “commodity information”) regarding a commodity name, a type, a price, and the like of the commodity corresponding to the commodity code. The POS terminal 20 executes the commodity registration process by reading the commodity information regarding the commodity corresponding to the commodity code read by the reading device 10 from the PLU file and temporarily storing the commodity information in the RAM 204 or the like. The storage unit 205 may store the PLU file to which the reading device 10 can refer.

In addition, the POS terminal 20 includes a communication interface 206. The communication interface 206 executes data communication with another device (reading device 10) via a connection line such as a LAN cable.

The hardware configurations of the reading device 10 and the POS terminal 20 are not limited to that of FIG. 4. For example, FIG. 4 illustrates the configuration in which the drawer 30 is included in the POS terminal 20. However, the drawer 30 may be connected to the POS terminal 20 as a separate device from the POS terminal 20.

Next, functional configurations of the reading device 10 and the POS terminal 20 will be described with reference to FIG. 5. FIG. 5 is a diagram showing an example of the functional configurations of the reading device 10 and the POS terminal 20. In FIG. 5, functional configurations relating between the reading device 10 and the POS terminal 20 is connected by a broken line.

As illustrated in FIG. 5, the reading device 10 includes an image acquisition unit 121, a reading unit 122, and an output control unit 123 as the functional configurations.

A part or all of the functional configurations in the reading device 10 may be implemented as a software configuration by cooperation of the CPU 102 and various programs stored in the storage unit 105. In addition, a part or all of the functional configurations in the reading device 10 may be implemented with hardware configurations such as the CPU 102 or a dedicated circuit.

The image acquisition unit 121 acquires an image acquired by the imaging unit 12 in cooperation with the imaging unit 12. Specifically, if transaction start is instructed by an operation received through the keyboard 14 or the first display unit 13 or by a signal notified from the POS terminal 20, the image acquisition unit 121 starts taking in the image data acquired by the imaging unit 12. In addition, if transaction end is instructed by an operation received through the keyboard 14 or the first display unit 13 or by a signal notified from the POS terminal 20, the image acquisition unit 121 stops taking in the image data.

The image acquisition unit 121 may control the start or end of imaging in response to the instruction of the start or end of transaction by controlling the operation of the imaging unit 12. In addition, by using a well-known technique such as object detection, the image acquisition unit 121 may acquire only an image acquired by imaging an article of which the distance from the imaging unit 12 (imaging window 111) is within a threshold. As a result, the image acquisition unit 121 can efficiently acquire the image acquired by imaging the commodity.

The reading unit 122 is an example of the first reading means, the second reading means, and the third reading means. The reading unit 122 executes a reading process of reading various information regarding the package of the commodity from the image of the commodity acquired by the image acquisition unit 121. Specifically, the reading unit 122 reads the code symbol, the flag seal (flag figure), and the service label in cooperation with the first program PRa, the second program PRb, and the third program PRc stored in the storage unit 105.

More specifically, the reading unit 122 initially reads the code symbol from the image acquired by the image acquisition unit 121 by preferentially using the first program PRa. If the reading unit 122 succeeds to read the code symbol, the reading unit 122 reads the flag figure from the image acquired by the image acquisition unit 121 by using the second program PRb. If the reading unit 122 succeeds to read the flag figure, the reading unit 122 reads the service label from the image acquired by the image acquisition unit 121 by using the third program PRc.

Here, it is assumed that a period of time in which the reading unit 122 reads the flag figure, that is, a period of time in which the second program PRb is used (hereinafter, also referred to as “first wait time”) is predetermined. If the flag figure cannot be read within the first wait time, the reading unit 122 ends the use of the second program PRb, that is, stops reading the flag figure and is switched to the reading of code symbol using the first program PRa.

In this case, the reading unit 122 may be immediately switched to the first program PRa after ending the use of the second program PRb. Alternatively, while being switched to an image of the next commodity, the reading unit 122 may wait (stop) for the use of the first program PRa. In the former case, the reading unit 122, for example, discards a commodity code that is newly read while being switched to the image of the next commodity for invalidation such that the commodity code assigned to the same commodity is prevented from being repeatedly read. A method of detecting the image of the next commodity is not particularly limited. For example, the image of the next commodity may be detected based on a change in continuous time-series images (frame images), for example, using a known technique of detecting the switch of a subject.

In addition, it is preferable that a period of time in which the reading unit 122 reads the service label, that is a period of time in which the third program PRc is used (hereinafter, also referred to as “second wait time”) is not limited or set to be longer than the first wait time. If the reading unit 122 specifies the service content represented by the service label by reading the service label, the reading unit 122 ends the use of the third program PRc and is switched to the first program PRa. Here, as in the switch from the second program PRb to the first program PRa, the switch from the third program PRc to the first program PRa is executed in a state where the repeated reading of the commodity code is suppressed.

While the second program PRb and the third program PRc are used, the reading unit 122 may stop reading the code symbol using the first program PRa or may read the code symbol using the first program PRa concurrently (simultaneously). In the latter case, in order to suppress the repeated reading of the commodity code, it is preferable that the reading unit 122 invalidates the commodity code that is repeatedly read while being switched to the image of the next commodity. In addition, if the reading unit 122 succeeds to read the flag figure, it is preferable that the reading unit 122 notifies the operator of the presence of the service label through the first display unit 13 or the like.

If various information is read from the image of the commodity acquired by the image acquisition unit 121, the reading unit 122 stores the read information as registration information regarding the commodity in the RAM 104 or the like. The registration information includes at least the commodity code and, if the service label is read, includes the service content corresponding to the read service label.

The output control unit 123 is an example of the output means. The output control unit 123 outputs information such as the commodity code and the like read by the reading unit 122 from the image of the commodity to the POS terminal 20. Specifically, the output control unit 123 outputs the registration information that is read from the image of the commodity in the reading process of the reading unit 122 to the POS terminal 20.

In addition, the output control unit 123 causes the first display unit 13 or the second display unit 15 to display a display screen based on the registration information. For example, the output control unit 123 causes the first display unit 13 or the second display unit 15 to display the commodity name, the price, and the like of the commodity corresponding to the commodity code in the registration information based on the PLU file stored in the storage unit 205 and the like of the POS terminal 20. In addition, if the registration information includes the service content, the output control unit 123 causes the first display unit 13 or the second display unit 15 to display the service content or the price and the like to which the service is applied.

On the other hand, as illustrated in FIG. 5, the POS terminal 20 includes an information acquisition unit 221, a sales data processing unit 222, and an output control unit 223 as functional configurations.

A part or all of the functional configurations in the POS terminal 20 may be implemented as a software configuration by cooperation of the CPU 202 and various programs stored in the storage unit 205. In addition, a part or all of the functional configurations in the POS terminal 20 may be implemented with hardware configurations such as the CPU 202 or a dedicated circuit.

The information acquisition unit 221 acquires the registration information read by the reading device 10. Specifically, the information acquisition unit 221 acquires the registration information input from the reading device 10.

The sales data processing unit 222 executes sales data processing relating to one transaction based on the registration information acquired by the information acquisition unit 221. Specifically, the sales data processing unit 222 executes the registration process of the commodity corresponding to the commodity code in the registration information based on the PLU file. In addition, if an operation to instruct the registration end for one transaction is received from the keyboard 22 and the like, the sales data processing unit 222 executes a settlement process of settling the total sum of the registered commodities based on the price and the like of each of the commodities.

If the registration information includes the service content, the sales data processing unit 222 applies the service content to the corresponding commodity and executes the registration process. For example, if the service content is an instruction for price reduction or discount, the sales data processing unit 222 executes the registration process based on a reduced price obtained by reducing the amount instructed by the service content from the price of the corresponding commodity.

The output control unit 223 controls the output of the process content or the process result of the sales data processing. For example, the output control unit 223 causes the display units 21 (the first display unit 211 and the second display unit 212) to display information regarding the commodities registered in the registration process. In addition, the output control unit 223 causes the display units 21 (the first display unit 211 and the second display unit 212) to display information or the like regarding the total sum of the commodities registered in one transaction or a payment amount paid by the customer. In addition, if the settlement process is completed, the output control unit 223 causes the receipt printer 23 to output a receipt on which information regarding the breakdown, the total sum, the paid amount, and the like of the commodities registered in one transaction are printed.

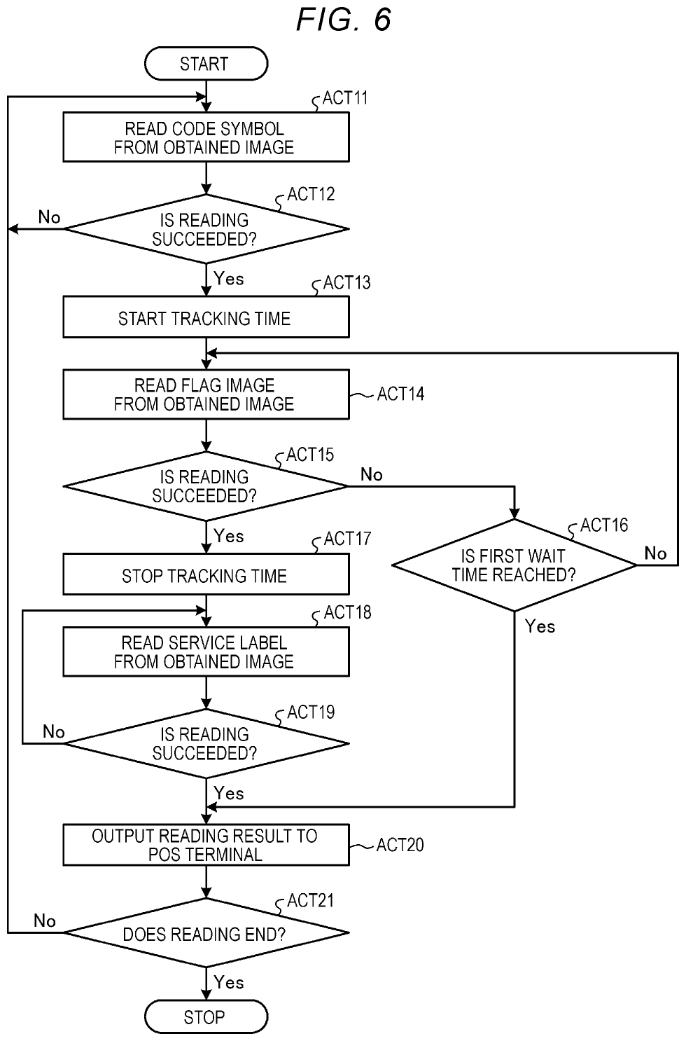

Next, the operation of the reading device 10 will be described with reference to FIG. 6. FIG. 6 is a flowchart illustrating an example of a process that is executed by the reading device 10. Assuming this process, the acquisition of the image by the image acquisition unit 121 is sequentially executed.

First, the reading unit 122 reads the code symbol from the image acquired by the imaging unit 12 by using the first program PRa (ACT 11). Next, the reading unit 122 determines whether or not the reading unit 122 succeeds to read the code symbol (ACT 12).

If the reading unit 122 does not succeed to read the code symbol (ACT 12: No), the reading unit 122 returns to ACT 11 and reads the code symbol again. In addition, if the reading unit 122 succeeds to read the code symbol (ACT 12: Yes), the reading unit 122 starts tracking time using a time tracking function (ACT 13) and proceeds to ACT 14.

Next, the reading unit 122 reads the flag figure from the image acquired by the imaging unit 12 by using the second program PRb (ACT 14). Next, the reading unit 122 determines whether or not the reading unit 122 succeeds to read the flag figure (ACT 15).

If the reading unit 122 does not succeed to read the flag figure (ACT 15: No), the reading unit 122 determines whether or not the tracked time reaches the first wait time (ACT 16). If the tracked time does not reach the first wait time (ACT 16: No), the reading unit 122 continues to read the flag figure by returning the process to ACT 14. In addition, if the tracked time reaches the first wait time (ACT 16: Yes), the reading unit 122 proceeds the process to ACT 20.

On the other hand, if the reading unit succeeds to read the flag figure in ACT 15 (ACT 15: Yes), the reading unit 122 stops and resets the tracked time by the time tracking function (ACT 17) and proceeds to ACT 18. If the reading unit 122 succeeds to read the flag figure, it is preferable that the reading unit 122 causes the first display unit 13 to display a message notifying the presence of the service label to urge the operator to read the service label.

Next, the reading unit 122 reads the service label from the image acquired by the imaging unit 12 by using the third program PRc (ACT 18). Next, the reading unit 122 determines whether or not the reading unit 122 succeeds to read the service label (ACT 19).

Here, if the reading unit 122 does not succeed to read the service label (ACT 19: NO), the reading unit 122 continues to read the service label by returning the process to ACT 18. In addition, if the reading unit 122 succeeds to read the service label (ACT 19: Yes), the reading unit 122 proceeds the process to ACT 20.

Next, the output control unit 123 outputs the information read by the reading unit 122 to the POS terminal 20 as the registration information (ACT 20). Specifically, the output control unit 123 outputs the commodity code read in ACT 11 and ACT 12. In addition, if the service label is read in ACT 18 and ACT 19, the output control unit 123 outputs not only the commodity code but also the service content corresponding to the service label.

Next, the reading unit 122 determines whether to end the reading process or not (ACT 21). For example, if reading end or registration end corresponding to one transaction is instructed by an operation received through the keyboard 14 or the first display unit 13 or by a signal notified from the POS terminal 20, the reading unit 122 determines to end the reading process.

If the reading unit 122 determines not to end the reading process (ACT 21: No), the reading unit 122 returns the process to ACT 11. On the other hand, if the reading unit 122 determines to end the reading process (ACT 21: Yes), the reading unit 122 ends the process.

As described above, the invisible code symbol is attached to each of the package surfaces of the commodity according to the embodiment, and if the commodity is a service target, the flag figure representing the presence of the service label is attached to each of the package surfaces to which the code symbol is attached.

In addition, the reading device 10 according to the embodiment reads the invisible code symbol attached to the package surface of the commodity from the image of the commodity acquired by the imaging unit 12. In addition, the reading device 10 reads the code symbol and subsequently reads the predetermined flag figure attached to the commodity as the service target from the image of the commodity acquired by the imaging unit 12. The reading device 10 reads the service label representing the service content from the image of the commodity acquired by the imaging unit 12 on a condition that the reading device 10 succeeds to read the flag figure.

As a result, if the reading device 10 succeeds to read the code symbol, the reading device 10 can read the flag figure from the package surface from which the code symbol is read. Therefore, the reading device 10 can efficiently read the flag figure from the commodity to which the invisible code symbol is attached. In addition, on the operator side, similarly, by directing the package surface to which the flag figure is attached to the imaging window 111, the code symbol and the flag figure can be efficiently read, which improves the convenience.

The above-described embodiment can also be appropriately modified and embodied by changing a part of the configurations or the functions of the reading device 10. Hereinafter, modification examples of the above-described embodiment will be described as other embodiments.

Hereinafter, different points from the above-described embodiment will be mainly described, and the detailed description of the common points of the above description will not be repeated. In addition, the modification examples described below may be embodied separately or may be appropriate combined.

### MODIFICATION EXAMPLE 1

In the above description of the embodiment, the code symbol is attached in the form of a digital watermark as information to all of the commodities that are sold in a store. However, the disclosure is not limited to this configuration, and commodities where a normal visible code symbol (hereinafter, also referred to as “normal code symbol”) is attached to a predetermined position of a package may be mixed.

In this case, the reading unit 122 may read the normal code symbol using the above-described first program PRa. However, it is preferable that the reading unit 122 reads the normal code symbol using a customized program for the normal code symbol. In addition, in this case, the reading unit 122 may change the first wait time in which the reading unit 122 waits for reading the flag figure depending on whether the read code symbol is a digital watermark or a normal code symbol (invisible or visible).

For example, in the case of the normal code symbol, the first wait time may be set to be longer than that of the digital watermark code symbol. In addition, conversely, in the case of the normal code symbol, the first wait time may be set to be shorter than that of the digital watermark code symbol. For example, if the flag seal is attached to the vicinity of the normal code symbol, the flag seal can be rapidly read. Therefore, it is preferable that the first wait time is shorter than that of the digital watermark code symbol.

A method of determining whether the read code symbol is a digital watermark or a normal code symbol is not particularly limited. For example, whether the read code symbol is a digital watermark or a normal code symbol may be determined based on the type of the program used for reading.

### MODIFICATION EXAMPLE 2

In the above-described embodiment, the tape-shaped seal member having the design in which a plurality of flag figures are continuously arranged is described as the example of the flag seal (refer to FIG. 3). However, the configuration of the flag seal is not limited to this example.

For example, the flag seal may contain information other than the flag figure. For example, the flag seal may contain, for example, a message representing a commodity as a service target. As a result, a customer can understand that a commodity is a service target by seeing the flag seal attached to a package surface of the commodity.

In addition, the flag seal is not limited to a tape shape and may have another shape, and an attachment method thereof is not particularly limited. If the entire package surface to which the code symbol is attached is covered with the flag seal, the code symbol cannot be read. Therefore, it is preferable that the area where the flag seal is attached is reduced, for example, is half or one fourth or less of the area of the package surface. In addition, in order to clarify a boundary with the pattern of the package surface, it is preferable that the ground of the flag seal is white or the like.

### MODIFICATION EXAMPLE 3

In the configuration of the above-described embodiment, the reading device 10 reads the information such as the commodity code from the image acquired by the imaging unit 12. However, the disclosure is not limited to this configuration, and the POS terminal 20 side may execute reading.

In this case, the reading device 10 outputs the image acquired by the imaging unit 12 to the POS terminal 20. The POS terminal 20 reads the information such as the commodity code from the image input from the reading device 10. Specifically, the POS terminal 20 has the functional configurations of the reading device 10 described in FIG. 5. As a result, with the function of the reading unit 122, the commodity code, the flag figure, and the service label can be read.

### MODIFICATION EXAMPLE 4

In the system configuration of the above-described embodiment, the reading device 10 and the POS terminal 20 are separately provided. However, the disclosure is not limited thereto and a single apparatus (hereinafter, also referred to as “sales data processing apparatus”) in which the reading device 10 and the POS terminal 20 are integrated may be adopted. In this case, the sales data processing apparatus may be a full-self-service type sales data processing apparatus that is operated by a customer.

The program that is executed by each of the devices according to the embodiment is embedded in a storage medium in advance, but the embodiment is not limited thereto. The program may be provided by being recorded in a computer-readable recording medium such as a CD-ROM, a flexible disk (FD), a CD-R, or a DVD (Digital Versatile Disk) in an installable or executable file format.

Further, the storage medium is not limited to a medium separate from a computer or an embedded system and may be a storage medium that stores or temporarily stores a program downloaded through a LAN or the Internet.

In addition, the program that is executed by the reading device 10 according to the embodiment may be provided by storing the program in a computer connected to a network such as the Internet and downloading the program through the network. In addition, the program that is executed by the reading device 10 according to the embodiment may be provided or distributed through a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A reading device comprising:
a first reader configured to read an invisible code symbol attached to each of package surfaces of a commodity from an image of the commodity acquired by an imaging device;
a second reader configured to read a predetermined flag figure attached to a commodity as a service target from the image;
a third reader configured to read a service label representing a content of a service that is provided during purchase of the commodity from the image on a condition that the second reader succeeds in reading the flag figure; and
an output configured to output a reading result of the first reader and, when the third reader reads the service label, output a reading result of the third reader,
wherein the flag figure is attached to each of the package surfaces to which the code symbol is attached, and
the second reader is configured to start reading the flag figure after the first reader reads the code symbol.

2. The device according to claim 1,
wherein the flag figure is printed in a seal member having a tape shape and is transversely attached to the package surface to which the code symbol is attached through the seal member.

3. The device according to claim 1,
wherein the code symbol is embedded in each of the package surfaces in the form of a digital watermark, and
the first reader is configured to read the code symbol embedded in the package surface from the image.

4. The device according to claim 1,
wherein the first reader is configured to stop reading the code symbol in response to start of reading the flag figure by the second reader.

5. The device according to claim 1,
wherein on the condition the second reader fails to read the flag figure for a predetermined period of time, the second reader stops reading the flag figure.

6. A method for causing a computer of a reading device to function as:
a first reader configured to read an invisible code symbol attached to each of package surfaces of a commodity from an image of the commodity acquired by an imaging device;
a second reader configured to read a predetermined flag figure attached to a commodity as a service target from the image;
a third reader configured to read a service label representing a content of a service that is provided during purchase of the commodity from the image on a condition that the second reader succeeds to read the flag figure; and
an output configured to output a reading result of the first reader and, on the condition the third reader reads the service label, output a reading result of the third reader,
wherein the flag figure is attached to each of the package surfaces to which the code symbol is attached, and
the second reader is configured to start reading the flag figure after the first reader reads the code symbol.

7. The device according to claim 1, wherein the service label contains information regarding price reduction or discount of the commodity.

8. The device according to claim 1, wherein the first reader, the second reader, and the third reader include the same reader.

9. The device according to claim 1, wherein the first reader, the second reader, and the third reader include different readers.

10. The device according to claim 1, wherein the invisible code symbol includes information on a commodity code based on at least one of commodity type, or commodity name.

11. The device according to claim 1, wherein the first reader, the second reader, and the third reader include an image configured to read.

12. The device according to claim 1, wherein the second reader is configured to read the predetermined flag figure over a first wait time, the third reader is configured to read the service label over a second wait time, and the second wait time is greater than the first wait time.

13. The device according to claim 2, wherein the service label is attached to overlap the seal member.

14. The device according to claim 1, wherein the first reader, the second reader, and the third reader are configured to read simultaneously.

15. The method according to claim 6, wherein the flag figure is printed in a seal member having a tape shape and is transversely attached to the package surface to which the code symbol is attached through the seal member.

16. The method according to claim 6,
wherein the code symbol is embedded in each of the package surfaces in the form of a digital watermark, and
the first reader is configured to read the code symbol embedded in the package surface from the image.

17. The method according to claim 6,
wherein the first reader is configured to stop reading the code symbol in response to start of reading the flag figure by the second reader.

18. The method according to claim 6,
wherein on the condition the second reader fails to read the flag figure for a predetermined period of time, the second reader stops reading the flag figure.
